(19) United States
(12) Patent Application Publication
(10) Pub. No.: US 2016/0154248 A1
(43) Pub. Date: Jun. 2, 2016

(54) METHOD FOR DETECTING IMAGE IN IMAGE DETECTOR HAVING EDGE MILLED APERTURE TO REMOVE DIFFRACTION PATTERN

(71) Applicant: Electronics and Telecommunications Research Institute, Daejeon (KR)

(72) Inventor: Wang Joo LEE, Daejeon (KR)

(21) Appl. No.: 14/803,675

(22) Filed: Jul. 20, 2015

(30) Foreign Application Priority Data
Nov. 27, 2014 (KR) 10-2014-0167001

(51) Int. Cl. G02B 27/58

(52) U.S. Cl. CPC G02B 27/58

(57) ABSTRACT

The present invention relates to an image detecting method of an image detector which processes a shape of an edge of an image input aperture of a 2D image detector which is used in a terahertz band whose frequency is lower than that of infrared light to have a predetermined shape so that a diffraction pattern due to the aperture is not shown in a captured image or a contrast is weakened, thereby obtaining a clear object image with a reduced distortion.

### CROSS-REFERENCE TO RELATED APPLICATIONS

This application claims priority to and the benefit of Korean Patent Application No. 10-2004-0167001 filed in the Korean Intellectual Property Office on Nov. 27, 2014, the entire contents of which are incorporated herein by reference.

### TECHNICAL FIELD

The present invention relates to an image detecting method of an image detector, and more particularly, to a method for detecting an image in an image detector (or sensor) which processes an edge of an image input aperture of an image detector to have a predetermined shape, thereby removing an unwanted diffraction pattern.

### BACKGROUND ART

When a coherent wave passes through a narrow hole, a diffraction pattern is created. The interval of the diffraction patterns varies depending on a relative size ratio of a wavelength and a hole (or an obstacle). As the hole size is increased as compared with the wavelength, the interval of the patterns is reduced and as the hole size is decreased, the interval of the patterns is increased. When the diffraction pattern is smaller than a pixel of an image detector which is located next to the hole, the pattern is not recognized, but when the interval of the patterns is larger than a pixel of a 2D detector, a virtual image is created.

For example, in an optical device such as a telescope or a camera, since the diameter of an incident aperture is generally 1 cm or larger and the wavelength is smaller than 1 μm, the size ratio is ten thousand or larger so that even though the diffraction pattern is generated, the interval of the diffraction patterns is too narrow to be recognized by the detector. In contrast, in the microwave or terahertz region having a wavelength of mm or larger, when the detector is used, the diffraction pattern due to the finite size aperture may be easily recognized.

FIG. 1 illustrates examples of diffraction patterns in accordance with a size D of an incident aperture and a wavelength λ when a coherent light source is used. FIG. 1 illustrates that the generation of diffraction pattern is simulated after passing though the aperture when the aperture size D is equal to or more than ten times of the wavelength λ. It is understood that as the ratio of the aperture size with respect to the wavelength is increased, the interval of diffraction patterns is reduced. When the interval of patterns is smaller than the pixel of the detector, eventually, the diffraction pattern may not be recognized.

FIG. 2A is an example of a 2D detector having double apertures (37 mm and 12 mm). FIG. 2B is an example of a diffraction pattern of a 200 GHz gyrotron output beam photographed by the 2D detector of FIG. 2A. When the 200 GHz gyrotron output beam is photographed using the 2D detector having double apertures as illustrated in FIG. 2A, it is confirmed that diffraction patterns having a circle and a straight line are clearly shown as illustrated in FIG. 2B.

As described above, since a diffraction pattern is generated due to an aperture of the detector in a band of terahertz wave or longer whose wavelength is much longer than that of visible light or infrared light, the image quality may be lowered. For example, in the case of usual photography, the input aperture of the detector is sufficiently thousand times larger than the wavelength. In contrast, in the case of a 2D image detector of a terahertz band, the input aperture is just several ten times larger than the wavelength, so that an unwanted diffraction pattern due to the aperture may be shown.

### SUMMARY OF THE INVENTION

The present invention has been made in an effort to provide an image detecting method of an image detector which processes a shape of an edge of an image input aperture of a 2D image detector which is used in a terahertz band whose frequency is lower than that of infrared light to have a predetermined shape so that a diffraction pattern due to the aperture is not shown in a captured image or the contrast of the diffraction pattern is weakened, thereby obtaining a clear object image with a reduced distortion.

An exemplary embodiment of the present invention provides an apparatus for detecting an image by passing an electromagnetic wave, the apparatus includes an aperture having a predetermined shape to pass an electromagnetic wave, in which the aperture is milled such that a transmittance is gradually reduced from an end of an edge of the aperture to the material surface.

The transmittance may be entirely reduced from the end of the edge of the aperture up to almost one wavelength of the electromagnetic wave, for example, up to a length corresponding to one wavelength and ±10% of a wavelength of the electromagnetic wave.

The aperture may be formed such that the transmittance is entirely reduced from the end of the edge of the aperture to the material surface to have a predetermined gradient.

The aperture may be formed to have a plurality of levels of transmittance which is entirely reduced from the end of the edge of the aperture to the material surface.

The aperture may be formed such that an average of the transmittance is entirely reduced from the end of the edge of the aperture to the material surface.

The end of the edge of the aperture may have a sawtooth shape or irregularities having valleys and mountains.

Intensity distribution of the electromagnetic wave may have a gradient from the edge of the aperture to the material surface so that diffraction is removed or reduced.

Another exemplary embodiment of the present invention provides a method for detecting an image by passing an electromagnetic wave, the method includes passing an electromagnetic wave through an aperture having a predetermined shape to electromagnetically obtain an image or project the image onto a screen, in which the aperture is milled such that a transmittance is reduced from an end of an edge of the aperture to a material surface.

The transmittance may be entirely reduced from the end of the edge of the aperture up to almost one wavelength of the electromagnetic wave, for example, up to a length corresponding to one wavelength and ±10% of a wavelength of the electromagnetic wave.

The aperture may be formed such that the transmittance is entirely reduced from the end of the edge of the aperture to the material surface to have a predetermined gradient.

The aperture may be formed to have a plurality of levels of transmittance which is entirely reduced from the end of the edge of the aperture to the material surface. The aperture may be formed such that an average of the transmittance is entirely reduced from the end of the edge of the aperture to the material surface.

The end of the edge of the aperture may have a sawtooth shape or irregularities having periodic valleys and mountains.

Intensity distribution of the electromagnetic wave may have a gradient from the edge of the aperture to the material surface so that diffraction is removed or reduced.

According to an image detecting method of an image detector according to an exemplary embodiment of the present invention, an edge of an image input aperture of a 2D image detector has a transmissive gradient or a sawtooth shape, so that a diffraction pattern is not shown in a captured image in a terahertz band whose frequency is lower than that of infrared light or a contrast is weakened, thereby obtaining a clear object image with less distortion.

### BRIEF DESCRIPTION OF THE DRAWINGS

FIG. 1 illustrates examples of diffraction patterns in accordance with a size D of an incident aperture and a wavelength λ when a coherent light source is used.

FIG. 2A is an example of a 2D detector having double apertures (37 mm and 12 mm).

FIG. 2B is an example of a diffraction pattern of a 200 GHz gyrotron output beam photographed by the 2D detector of FIG. 2A.

FIG. 3 illustrates a propagation characteristic of a step form wave in an image input aperture to explain a principle of usual diffraction pattern formation in usual case.

FIG. 4 illustrates a propagation characteristic of a Gaussian beam to explain a principle of diffraction pattern not-formation.

FIG. 5 is a view explaining an image detector having an edge milled aperture to have a gradient transmittance according to an exemplary embodiment of the present invention.

FIG. 6 is an example of an electromagnetic wave passing simulation using an image detector having an aperture of FIG. 5.

FIG. 7A, FIG. 7B, and FIG. 7C are views explaining an image detector having an edge milled aperture to have a sawtooth shape according to another exemplary embodiment of the present invention.

FIG. 8 is an experiment result using an aperture according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present invention will be described in detail with reference to the accompanying drawings. In this case, like components are denoted by like reference numerals in the drawings as much as possible. Further, a detailed description of a function and/or a configuration which has been already publicly known will be omitted. In the following description, parts which are required to understand an operation according to various exemplary embodiments will be mainly described and a description on components which may cloud a gist of the description will be omitted. Some components of the drawings will be exaggerated, omitted, or schematically illustrated. However, a size of the component does not completely reflect an actual size and thus the description is not limited by a relative size or interval of the components illustrated in the drawings.

First, an image detector according to an exemplary embodiment of the present invention refers to all devices which allow an electromagnetic wave to pass to obtain an image, such as an image sensor which allows an electromagnetic wave of a terahertz band to pass through an edge milled image input aperture as described below to electromagnetically obtain an image to be displayed on a display device or an image projector which projects the image onto a screen using an optical system.

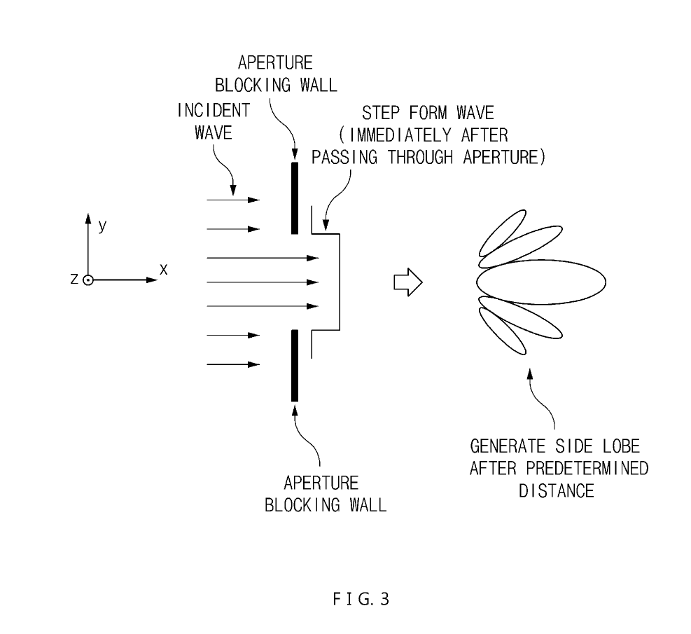

FIG. 3 illustrates a propagation characteristic of a step form wave in an image input aperture to explain a principle of diffraction pattern formation in usual case.

As illustrated in FIG. 3, when an electromagnetic wave such as a terahertz wave passes through a typical aperture, diffraction easily occurs due to the step intensity distribution in a direction (a y direction) which is perpendicular to a propagation direction (x) of the electromagnetic wave. Such a step form wave is generated immediately after a plane wave passes through an opaque aperture and continuously propagates in a propagation direction x so that side lobes propagating in various directions other than a propagation direction x of a major beam is generated. So, when the side lobe reaches the screen or the detector, a diffraction pattern is generated.

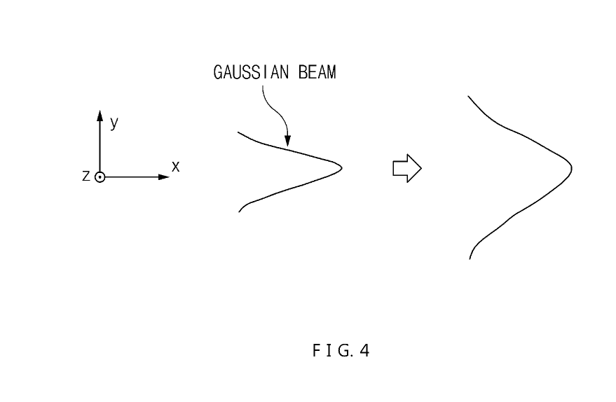

FIG. 4 illustrates a propagation characteristic of a Gaussian beam to explain a principle of diffraction pattern not-formation according to an exemplary embodiment of the present invention.

As illustrated in FIG. 4, in the case of an electromagnetic beam having a Gaussian intensity distribution in a direction (a y direction) which is perpendicular to the propagation direction x, as the electromagnetic beam continuously propagates in the propagation direction x, only the size of the beam is increased but the side lobe is not generated. Therefore, the electromagnetic beam does not generate a diffraction pattern.

As seen from FIGS. 3 and 4, intensity distribution in a direction (a y direction) which is perpendicular to the propagation direction x of the electromagnetic beam is closely related with the diffraction pattern. Further, when an intensity at an edge of the beam is smoothly reduced, the diffraction pattern is suppressed.

Using the above principle, according to the exemplary embodiment of the present invention, an intensity distribution (envelope) at an edge of the electromagnetic wave which passes an incident aperture is modified to have a gradient so that the diffraction phenomenon may be weakened.

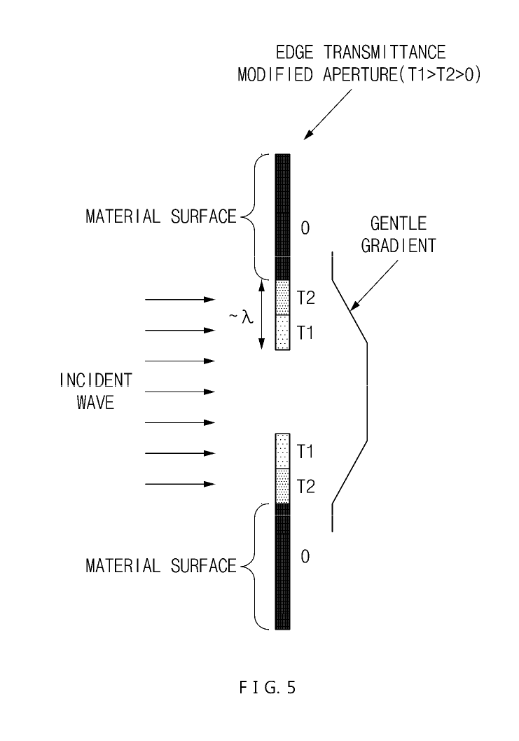

FIG. 5 is a view explaining an image detector having an edge milled aperture to have a gradient transmittance according to an exemplary embodiment of the present invention.

Referring to FIG. 5, the image detector according to an exemplary embodiment of the present invention includes an aperture which is formed of a predetermined material, such as metal or plastic, in order to pass the electromagnetic beam without being diffracted.

That is, the aperture may have various shapes such as a circle or a rectangle and at the edge of the aperture, a transmittance is entirely reduced approximately up to a length corresponding to almost one wavelength λ (for example, one ±10% of a wavelength) of the electromagnetic wave, which is incident, from an end to a material surface.

The transmittance at the edge of the aperture may be reduced to have a linear gradient or reduced at a plurality of levels (for example, T1 and T2), as illustrated in FIG. 5, from an end of the edge of the aperture to the material surface (for example, T1>T2>0). To this end, the edge may be milled to be formed such that a thickness is gradually and linearly increased from an end of the edge of the aperture to the material surface or formed by gradually increasing a thickness toward the material surface stepwise (a plurality of levels) or by connecting materials (a plurality of levels) whose transmittance is gradually decreased toward the material surface.

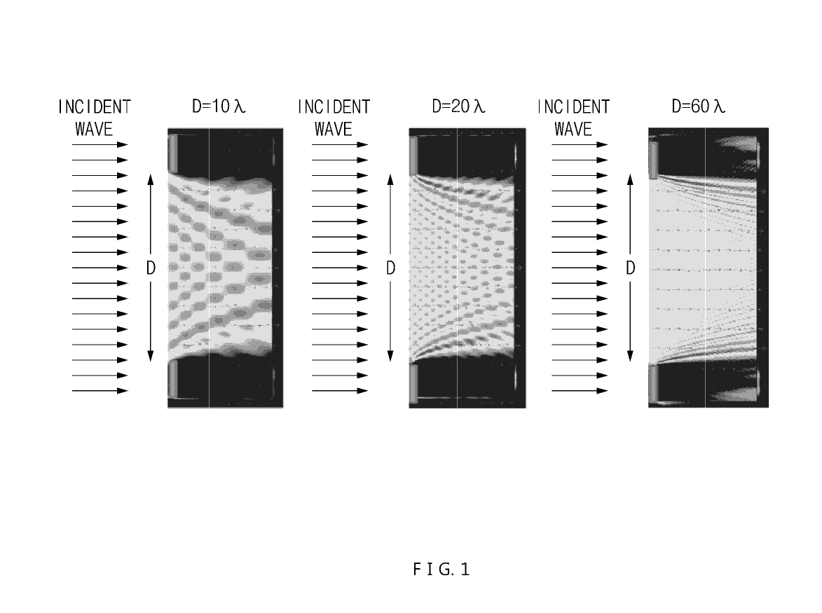

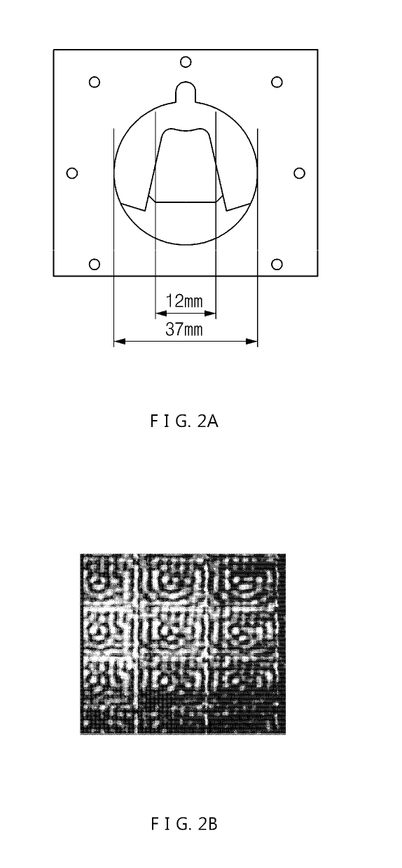

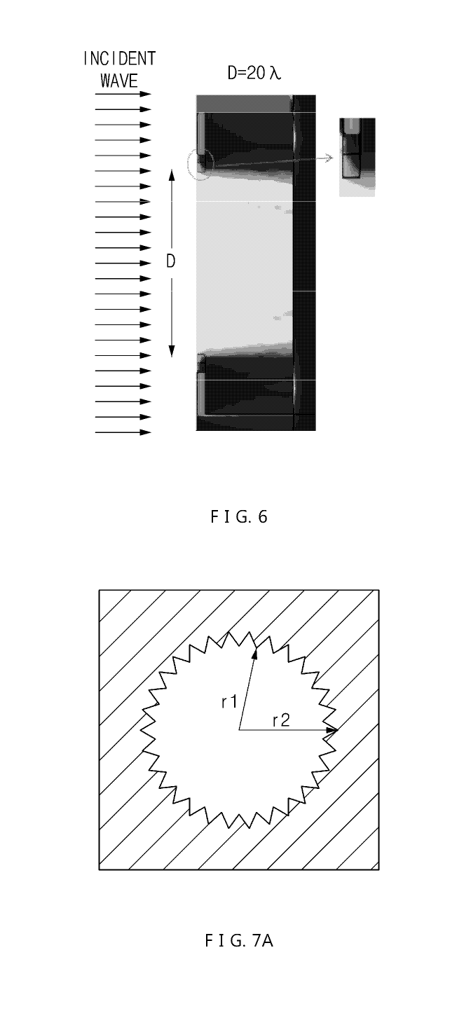

When the electromagnetic wave of wavelength λ passes through an aperture of size of D(D=20λ) with an edge described above, the simulation result shows that the diffraction pattern is significantly relieved as illustrated in FIG. 6, compared with the case when D=20λ as illustrated in FIG. 1.

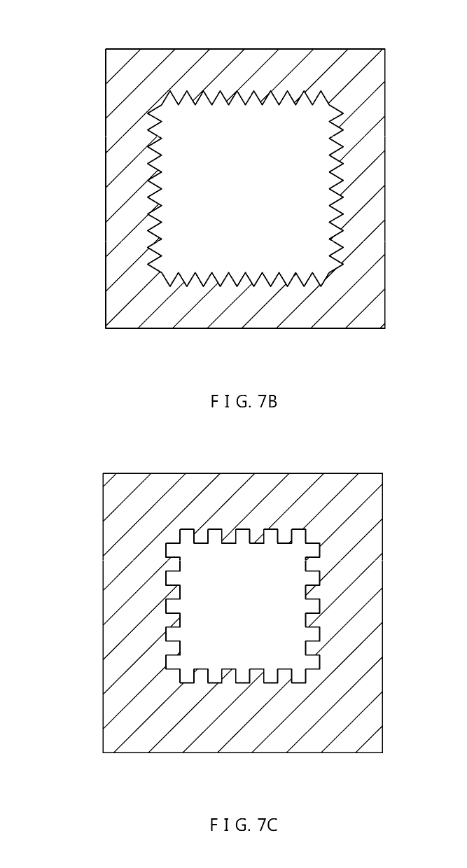

FIG. 7A, FIG. 7B, and FIG. 7C are views explaining an edge milled aperture to have a sawtooth shape according to another exemplary embodiment of the present invention.

As illustrated in FIG. 7A, FIG. 7B, and FIG. 7C, in order to achieve a gradient of transmittance at the edge of the aperture which passes the electromagnetic wave, the end of the edge of the aperture may be milled to have a sawtooth shape having valleys and mountains. That is, as illustrated in FIG. 7A, when an end of an edge of a circular aperture is milled to have a sawtooth shape, as for a distance r1 from a center to a mountain of the sawtooth and a distance r2 from the center to a valley of the sawtooth, 100% of the electromagnetic beam passes at r (a distance from the center)<r1 and 0% of the electromagnetic beam passes at r (the distance from the center)>r2, and an average transmittance is gradually reduced at r1<r<r2.

Similarly, as illustrated in FIG. 7B, when an end of an edge of a rectangular aperture is milled to have a sawtooth shape and the electromagnetic wave passes through the aperture, the transmittance gradient at the edge of the aperture may be achieved.

Similarly, as illustrated in FIG. 7C, when an end of an edge of an aperture is milled to have irregularities and a phase at the edge of the aperture when the electromagnetic wave passes through the aperture is changed to reduce the diffraction pattern. Here, even though the rectangular aperture is exemplified, the circular aperture as illustrated in FIG. 7A may be also formed such that an end of the aperture may be milled to have irregularities so as not to be sharp.

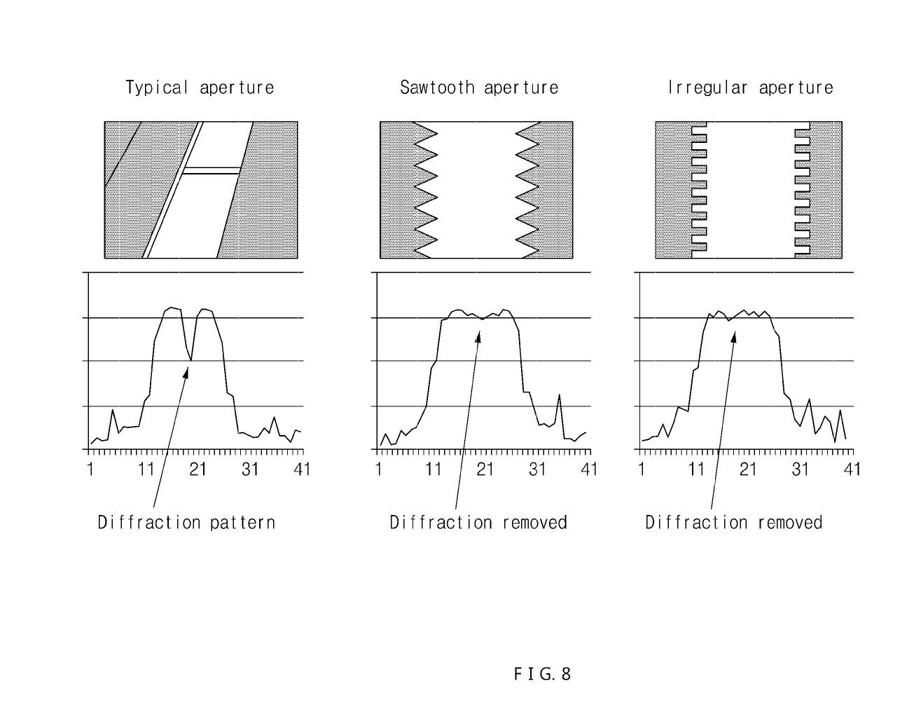

FIG. 8 is an experiment result using a one-dimensional (an x direction) aperture in order to clearly achieve an effect of removing a diffraction pattern of the exemplary embodiment of the present invention. It is understood that the diffraction pattern is removed at the sawtooth aperture and an aperture having irregularities.

As described above, according to an image detecting method of an image detector according to an exemplary embodiment of the present invention, an edge of an image input aperture of a 2D image detector is milled to have a transmissive slope or a sawtooth shape, so that a diffraction pattern is not shown in a captured image in a terahertz band whose frequency is lower than that of infrared light or a contrast is weakened, thereby obtaining a clear object image with a less distortion.

The specified matters and limited exemplary embodiments and drawings such as specific elements in the present invention have been disclosed for broader understanding of the present invention, but the present invention is not limited to the exemplary embodiments, and various modifications and changes are possible by those skilled in the art without departing from an essential characteristic of the present invention. Therefore, the spirit of the present invention is defined by the appended claims rather than by the description preceding them, and all changes and modifications that fall within metes and bounds of the claims, or equivalents of such metes and bounds are therefore intended to be embraced by the range of the spirit of the present invention.

What is claimed is:

1. An apparatus for detecting an image by passing an electromagnetic wave, the apparatus comprising:
an aperture having a predetermined shape to pass an electromagnetic wave,
wherein the aperture is milled such that a transmittance is reduced from an end of an edge of the aperture to a material surface.

2. The apparatus of claim 1, wherein the transmittance is entirely reduced from the end of the edge of the aperture up to a length corresponding to almost one wavelength of the electromagnetic wave.

3. The apparatus of claim 1, wherein the aperture is formed such that the transmittance is entirely reduced from the end of the edge of the aperture to the material surface to have a predetermined gradient.

4. The apparatus of claim 1, wherein the aperture is formed to have a plurality of levels of transmittance which is entirely reduced from the end of the edge of the aperture to the material surface.

5. The apparatus of claim 1, wherein the aperture is formed such that an average of the transmittance is entirely reduced from the end of the edge of the aperture to the material surface.

6. The apparatus of claim 1, wherein the end of the edge of the aperture has a sawtooth shape or irregularities having valleys and mountains.

7. The apparatus of claim 1, wherein intensity distribution of the electromagnetic wave has a gradient from the edge of the aperture to the material surface so that diffraction is removed or reduced.

8. A method for detecting an image by passing an electromagnetic wave, the method comprising:
passing an electromagnetic wave through an aperture having a predetermined shape to electromagnetically obtain an image or project the image onto a screen,
wherein the aperture is milled such that a transmittance is reduced from an end of an edge of the aperture to a material surface.

9. The method of claim 8, wherein the transmittance is entirely reduced from the end of the edge of the aperture up to almost one wavelength of the electromagnetic wave.

10. The method of claim 8, wherein the aperture is formed such that the transmittance is entirely reduced from the end of the edge of the aperture to the material surface to have a predetermined gradient.

11. The method of claim 8, wherein the aperture is formed to have a plurality of levels of transmittance which is entirely reduced from the end of the edge of the aperture to the material surface.

12. The method of claim 8, wherein the aperture is formed such that an average of the transmittance is entirely reduced from the end of the edge of the aperture to the material surface.

13. The method of claim 8, wherein the end of the edge of the aperture has a sawtooth shape or irregularities having valleys and mountains.

14. The method of claim 8, wherein intensity distribution of the electromagnetic wave has a gradient from the edge of the aperture to the material surface so that diffraction is removed or reduced.
